(19) United States
(12) Patent Application Publication
(10) Pub. No.: US 2012/0136731 A1
(43) Pub. Date: May 31, 2012

(54) METHOD AND SYSTEM FOR NUTRITIONAL PROFILING UTILIZING A TRAINABLE DATABASE

(76) Inventors: Adam E. Kidron, Bronx, NY (US); Michael Shuman, New York, NY (US)

(21) Appl. No.: 13/060,239

(22) PCT Filed: Aug. 27, 2009
(86) PCT No.: PCT/US2009/055150

§ 371 Date: May 23, 2011

Related U.S. Application Data
(60) Provisional application No. 61/092,175, filed on Aug. 27, 2008.

(51) Int. Cl. G06Q 50/12

(52) U.S. Cl. 705/15

(57) ABSTRACT

The invention establishes a set of nutritional profiles in a data processing system, which are utilized to establish an optimal meal menu for a given time and location and with regard to a set of available ingredients. The invention includes a profiling routine where a set of characteristics of a particular individual is entered. The characteristics are aggregated with data saved for other patrons. When an individual with an established profile enters a networked eatery, they initiate a menu routine by entering their identification. The routine matches the information with the aggregated data to determine a patron match, which in turn is matched with the set of characteristics to determine an optimal menu plan. The optimal menu plan is matched with the set of available ingredients to produce a menu. Selected menu items are recorded to the patron's nutritional profile which can be visually represented in any of several formats.

### BACKGROUND OF THE INVENTION

1. Field of the Invention

The present invention relates to a method and system adapted for health management. More specifically, the present invention relates to a method and system for establishing a set of nutritional profiles in a data processing system wherein each of the profiles is utilized to establish an optimal meal menu at a given time and location and with regard to a set of available ingredients relative to a given location (i.e., a restaurant or eatery).

2. Description of the Prior Art

Americans spent approximately US$180-billion on fast food in 2005, including an average of US$53-million a month on McDonald's Happy Meals™. American kids spend over US$30-billion a year of their own money on junk food.

Fast food has become an ever-increasing portion of our food consumption. Fast food restaurants share of Americans total caloric intake quadrupled from 3% in 1977 to 12% in 1998. The huge economies of scale in purchasing and distribution of chains like McDonalds, as well as the innovations they have made in food preparation, have enabled them to market and sell inexpensive, yet tasty, fast food to a vast and rapidly growing global market.

The problem is that the majority of fast food is measurably unhealthy. There are many single fast food menu items that provide more than half a person's recommended intake of calories and many of those items get more than half of their calories from fats, often artery-clogging trans- and saturated fats.

The overwhelming majority of fast foods are over processed, over-sized, nutritionally deficient, and laced with almost indigestible high-fructose corn syrup, MSG, and other flavor enhancers designed to hook palates. The net result has been a crippling explosion in the instance of diabetes and obesity. Obesity is responsible for more premature deaths than smoking, drinking, and narcotics combined. Almost 60 million Americans are now insulin resistant and, therefore, susceptible to diabetes.

Nonetheless, there is no going back to the “family table.” For example, a survey by the U.S. Dept. of Energy concluded that the proportion of U.S. households that cooked less than once per day had risen by nearly 8% to 27.4% between 1993 and 2001. On the other hand, the existing fast food industry is beyond repair; it is tainted by the explosion of ill health and trapped in the never-ending cycles of price competition.

Various meal planning and diet management tools are known in the art. Such tools often include computer systems capable of analyzing nutritional content of food items for the purpose of achieving a health related goal, such as weight loss (e.g., low calorie, low fat), allergen avoidance (e.g., no milk products, no peanuts, etc.), health maintenance (e.g., low sodium, low fat), or dietary preference (e.g., vegetarian).

Computerized systems for meal planning and diet management usually comprise a user's profile. The user profile may comprise user-specific information, including height, weight, age, known allergies, etc. In light of the user's profile, the computerized system can generate a meal or diet plan that matches the users nutritional and/or health needs. Computerized systems for meal planning have been described, e.g., in U.S. Published Patent Apps. 2002/0046060, 2003/0208409, and 2006/0074716.

For any meal plan or diet program to be successful, a user must comply with the meal plan or diet program. Of course, users often do not comply with the meal plan or diet program. This problem is very regularly addressed in the prior art.

The most common solution for increasing user compliance with a meal plan or diet program is a combination of flexibility and convenience, although these concepts are not always complementary. Flexibility may be provided through providing ample food choices, generating creative meal combinations, and eliciting comprehensive user feedback. Convenience may be provided by designing a simple user interface, offering targeted meal choices, and making the system portable. Again, however, since flexibility can negatively impact convenience and vice versa, there is a continuing need for new and inventive systems that offer a user flexibility and convenience to solve the problem of user non-compliance.

### OBJECTS AND SUMMARY OF THE INVENTION

An object of the present invention is to provide a method and system for establishing a set of nutritional profiles which in turn are utilized to establish an optimal meal menu for a given time for a given eatery.

Another aspect of the present invention is to provide a new and inventive system that offers a user flexibility and convenience to solve the problem of user non-compliance.

Still another aspect of the present invention is to provide a visual representation of a user's nutritional profile for ease of use.

The present invention relates to a set of nutritional profiles in a data processing system, which are utilized to establish an optimal meal menu for a given time and location and with regard to a set of available ingredients. The invention includes a profiling routine where a set of characteristics of a particular individual is entered. The characteristics are aggregated with data saved for other patrons. When an individual with an established profile enters a networked eatery, they initiate a menu routine by entering their identification. The routine matches the information with the aggregated data to determine a patron match, which in turn is matched with the set of characteristics to determine an optimal menu plan. The optimal menu plan is matched with the set of available ingredients to produce a menu. Selected menu items are recorded to the patron's nutritional profile which can be visually represented in any of several formats.

According to an embodiment of the present invention there is provided a method and system for establishing a set of nutritional profiles in a data processing system wherein each of the profiles is utilized to establish an optimal meal menu at a given time and location and with regard to a set of available ingredients relative to a given location (i.e., a restaurant or eatery).

The method comprises a number of steps which begin with the initiation of a profile building routine within the data processing system. A set of characteristics of a particular individual is entered into a data file established for that individual, and saved to a first database so as to be accessible to queries from other routines for individual file data. The set of characteristics within the database is aggregated with data saved for the set of all other individual patrons entered into the database.

The system supporting the above described method comprises a centralized data processing system further comprising a set of routines for initiating, storing and comparing nutritional profiles. The system has a memory for storing and aggregating a set of characteristics of a particular individual patron, together with characteristics from other patrons, in a data file established for the individual and accessible to database queries for individual file data. A menu routine is located at a system node placed at a networked eatery, for entering a set of identification information relative to a patron of the eatery. First matching means are provided within the system for matching the set of identification information relative to the patron with the aggregated data to determine a patron match. Second matching means are provided for matching the patron match with the set of characteristics to determine an optimal menu plan. A third matching means for matching the optimal menu plan with the set of available ingredients for the networked eatery, to produce a menu for the patron, completes the system.

The system's initiating step further comprises the step of entering the identification information in the menu routine of a system node located in the eatery and wherein the node is in communication with the data processing center.

The identification (ID) information is entered into the menu routine by using a keyboard interoperatively connected to the node. As an alternative, or as a supplementary step, the ID information can be entered by swiping a key fob containing the ID information past a reader interoperatively connected to the node; and/or the information can be entered by swiping a card containing the identification information past a reader interoperatively connected to the node.

When an individual with an established profile enters a networked eatery and wants to utilize their nutritional profile for healthier eating choices as a patron, they initiate a menu routine, at the eatery, for entering a set of identification information. The routine matches the set of identification information relative to the patron with the aggregated data in the system database to determine a patron match. The patron match is then further matched with the set of characteristics to determine an optimal menu plan for the patron. In turn, the optimal menu plan is matched with the set of available ingredients available at the networked eatery to produce a menu for the patron. The set of characteristics include characteristics defining the particular individual's specific diet requirements; and, may also include characteristics defining the particular individual's specific nutritional goals.

For analysis and reporting purposes, the method further comprises the step of creating a set of one or more categories within the set of all individual patrons, wherein each of the categories is representative of a group of individual patrons who share a scored characteristic band. The characteristic band is calculated by adding points assigned to each characteristic within the set of characteristics.

As the patron makes selections from the optimized menu, the selected meal items are recorded to the patron's nutritional profile by the data processing system. The user profile tracks and categorizes every food item that the patron has ordered in the eatery, and a notice can then be sent to other members that fall within the same characteristic band.

Additionally, the use of the optimized menu allows the eatery patron to creating a customized meal. Unique meals can be given a name, and categorized in accordance with such parameters as calories, sugar content, ingredients, etc. Further, a notice identifying the named meal can be sent to other users of the system. Based on promotions being nm through the system, or simply based on number of transactions, points can be awarded to the eatery patron, in respect of the named meal. The points can be applicable for the purchase of goods and/or services available from the eatery or other designated vendors. The awarded points are accumulated in the eatery patron's system account until used to purchase goods or services in respect of the points.

System transactions can also generate a smart receipt in respect of a system use by the eatery patron. The smart receipt further comprises: a record of the transaction; a record of points issued in respect of a transaction; and, one or more visual presentations.

In addition to the various routines residing within the system, the system maintains a forms library within a second database of the data processing system; the forms representing one or more report formats. The second database can be, but is not required to be, co-located with the characteristics database. Among other things, the report formats depict a menu for the individual for a given meal and based upon a set of ingredients available at a selected location. Also available within the forms library is a visual representation of the profile of the individual patron.

The visual representations can be in one of several forms that include: a pyramid; a set of rings and circles; a ring set; and, an array of circles disposed in several horizontal rows.

The pyramid visualization is comprised of a set of three facets representing three different states of the corresponding patron. The set of three facets further comprise a first facet which is representative of the patron's profile and comprises a set of user provided attributes. The second facet is representative of the patron's nutritional goals and comprises patron defined nutrition/health related milestones. The third facet is a balancing point further comprising system generated recommendations of product purchases that direct the patron toward his or her goals.

The visualization characterized by the set of rings and circles includes a patron's profile visually represented by a core circle surrounded by a plurality of rings of varying size and position. The core circle being the patron's core preference or nutritional need; the outer rings each being an additional preference or need of the patron. The position of each of the rings is indicative of the relative importance of the respective addition preference or need; and, the size of each of the rings indicates the relative level of compliance by the patron with respect to the additional preference or need.

The third visual representation is a ring set, wherein the patron's profile is visually represented by three rings of fixed size and position, but varying segments. The outer ring represents the patron's current state; the middle ring represents the user's goals; and, the inner ring represents the system's recommendations for the patron. Each ring is divided into a plurality of segments or cells representing particular nutrition properties and the intensity of color in each cell represents the particular nutrition score in relation to the patron's preferences or needs.

The fourth visual representation is an array of circles disposed in several horizontal rows, wherein the first set of horizontal rows is indicative of the patron's current state; the second set of rows is indicative of the patron's goals; and, the third set of rows is indicative of the system's recommendations for the patron.

The above, and other objects, features and advantages of the present invention will become apparent from the following description read in conjunction with the accompanying drawings, in which like reference numerals designate the same elements.

### BRIEF DESCRIPTION OF THE DRAWINGS

The above and other features and advantages of the inventive system and method will be disclosed in detail in conjunctions with the following figures:

FIG. 1 is an overview diagram of the system of the present invention showing a host data processing center and three node sites;

FIG. 2A is an overview flowchart of the method of the present invention;

FIG. 2B is a flowchart of the process for obtaining information concerning diet and eating habits from a user;

FIG. 2C is a flowchart of the process for obtaining information concerning diet and eating goals from a user;

FIG. 3 is a visual representation of a unique nutritional identity for a user according to the present invention (the ‘unique’ identity being the later-described “DNA profile” for each user;

FIG. 4 is an alternative visual representation of a unique nutritional identity for a user according to the present invention;

FIG. 5 is a third visual representation of a unique nutritional identity for a user according to the present invention;

FIG. 6 is a fourth visual representation of a unique nutritional identity for a user according to the present invention;

FIG. 7 is an exploded perspective view of a whole burger of the present system and method;

FIG. 8 is a perspective view of the whole burger of FIG. 6 as assembled;

FIG. 9 is an exploded perspective view of an alternative whole burger of the present system and method comprising radial channels in the patty;

FIG. 10 is a perspective view of the whole burger of FIG. 8 as assembled;

FIG. 11 is a diagram showing hardware for the system of the present invention and exemplary communications between users and the system according to the present invention;

FIG. 12A is a pictorial diagram of a common geometric series of progression representing an infinite series with a definite sum bounded by a mathematical resolution subject to calculus, here representing the possible combinations of links and cross-links between member/customer/users and options determined by a system manager and created within the managed database such as possible built (burger or meal of any kind) combinations; and

FIG. 12B is a pictorial diagram of an uncommon geometric series of progression representing an infinite series with a definite sum also bounded by mathematical resolution but illustrating an organic or natural growth progression of links involving market factors such as member/customer/user marketing actions, popularity of a particular build combination; and other features as enabled within the created database.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

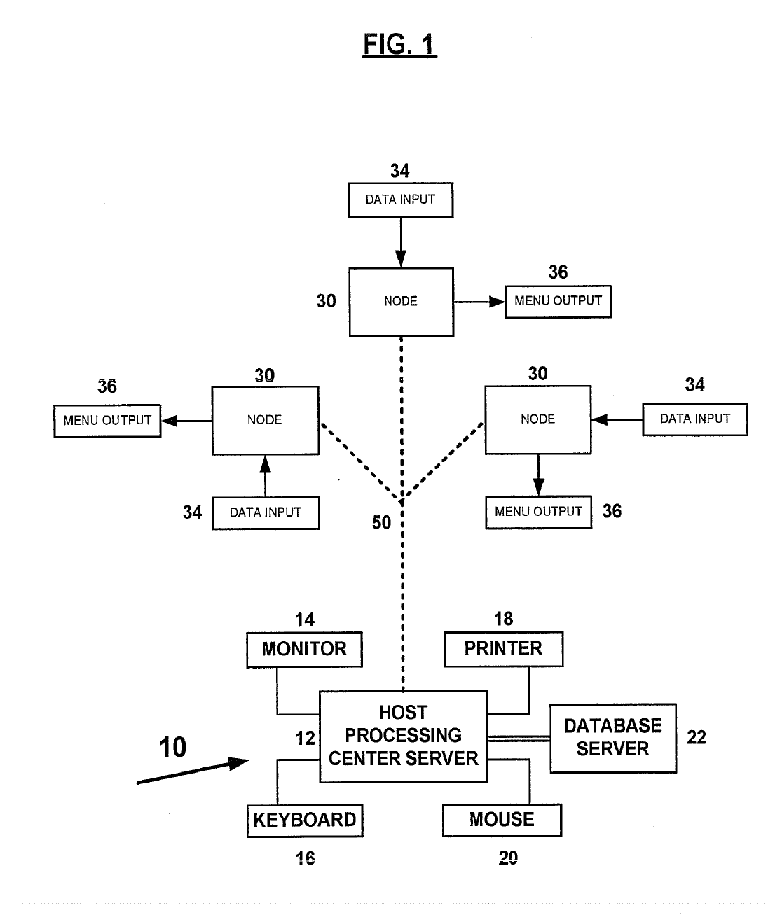

Turning first to FIG. 1, there is shown an overview of the system 10 of the present invention which is hosted at a host data processing center 12. The host 12 has a monitor 14 for viewing system transactions and generally aiding in the daily activities of system maintenance. The system 10 has a keyboard 16 for data entry, and a printer 18 for printing data in whatever form is selected by the system user. The printer 18 can be used to print reports relative to the system and derived from the data stored at the database server 22 or within the system memory. Additionally, the system 10 has a mouse 20 that is also used for data entry and user interface with the system's various routines.

System 10 is connected with each of its remote nodes 30 via a communication link 50. The remote nodes 30 are generally eateries (such as restaurants, diners and certain delicatessens) where routines have been established within the node's own localized data processing system to implement the routines and method of the present invention. Each node has at least a data input device or peripheral 34 for capturing data relative to a registered patron. Data input can be captured through, but is not limited to, a keyboard, a scanner, a fob or card reader, or by communication linking devices such as a PDA or cellphone. Once the system's routines have generated a patron personalized menu, the menu can output 36 through devices such as a monitor for viewing, a printer, a download capable of being read at a remote location such as a waiter stand.

### 1. Registration and Profiling

The present invention aggregates customers/users into the minimal number of nutrition groups/categories (“buckets”) that efficiently and usefully enable contextual menu-suggestions. A primary consideration is to ensure that each customer will have to answer the minimum of questions to be categorized into one or more pre-determined nutrition buckets. The buckets may be incredibly detailed and specific. Examples of Buckets include: Low Fiber, Egg Free, High Fiber, High Omega 3, Low Trans/Saturated Fat, Low refined CHO (Sugar), Gluten Free, High Iron, Wheat Free, High Calcium, Dairy Free, High Protein, Meat Free, High Anti-oxidant, Red Meat Free, High Anti-inflammatory, Low Carbohydrate, and Low Sodium. Preferably, each user can be categorized into one or two buckets.

The process of data-basing comprises two stages, registration and profiling. Profiling may be further comprise diet/eating habits, goals, and diagnostic. Customer yield will increase inversely to the amount of questions asked of the customers/users and proportionately to the relevance of each question. As maximizing the effectiveness of each question is a priority, it is imperative that a system according to the present invention comprises “smart paths”—logical chains of questions that relate each question to the particular answer given by the customer/user to the previous question.

Registration enables the user/customer to order online, access past receipts, build a burger or meal, and “trade”—marketing burgers and earning cash, including the ability to “name-a-burger” or meal a designated special name if it becomes sufficiently popular with the users of the system. Registration enables users/customers to use all of the systems social networking tools. At a minimum, a user/customer must complete demographic questions, such as Name, Username, Password, Age, Gender, and Activity Level (e.g., sedentary, moderately active, active, or very active). A female user may also be asked if she is pregnant and/or nursing.

An important demographic question is Activity Level, which may have a sub-question that borrows into the specifics of activity. For example if user/customer has answered Activity Level as “extremely high” or “very active,” the user/customer may be asked to describe the activity, such as Decathlete, Iron Man, long distance swimmer, competitive body-builder, professional athlete, etc. Moreover, questions, such as Activity Level, are “accelerator questions” or because answers to such questions allow the system to more quickly identify the appropriate bucket for the user/customer. For example, if the user/customer has answered Activity Level as “extremely high,” the user/customer may not need to answer any questions concerning their diligence in exercise. In other words, the system, in response to certain answers for accelerator questions, may ask the user/customer fewer questions.

Profiling the user/customer is fundamental to the system of the present invention. Profiling enables the system to understand the users/customers sufficiently to make accurate contextual suggestions from the food menu. The user/customer answers given to questions asked in these three segments enable the system to create a unique, nutrition identification for each user/customer.

1a. Questions Concerning Diet and Eating Habits

Questions of a nearly endless variety concerning diet and eating habits are designed by the system manager to place the user/customer onto one or more pre-determined buckets, and ultimately to aid in creating a unique identify for the user. From a database perspective, what happens is that placing a user in a bucket restricts contextual questions and system recommendations/suggestions to the items tagged to that specific bucket, and those tagged menu items may then be further modified by those options that are of a second bucket. Indeed, the entire system works in this way, each answer modifies the menu for that particular user/customer—leaving only those menu item that most suit the user/customer's profile.

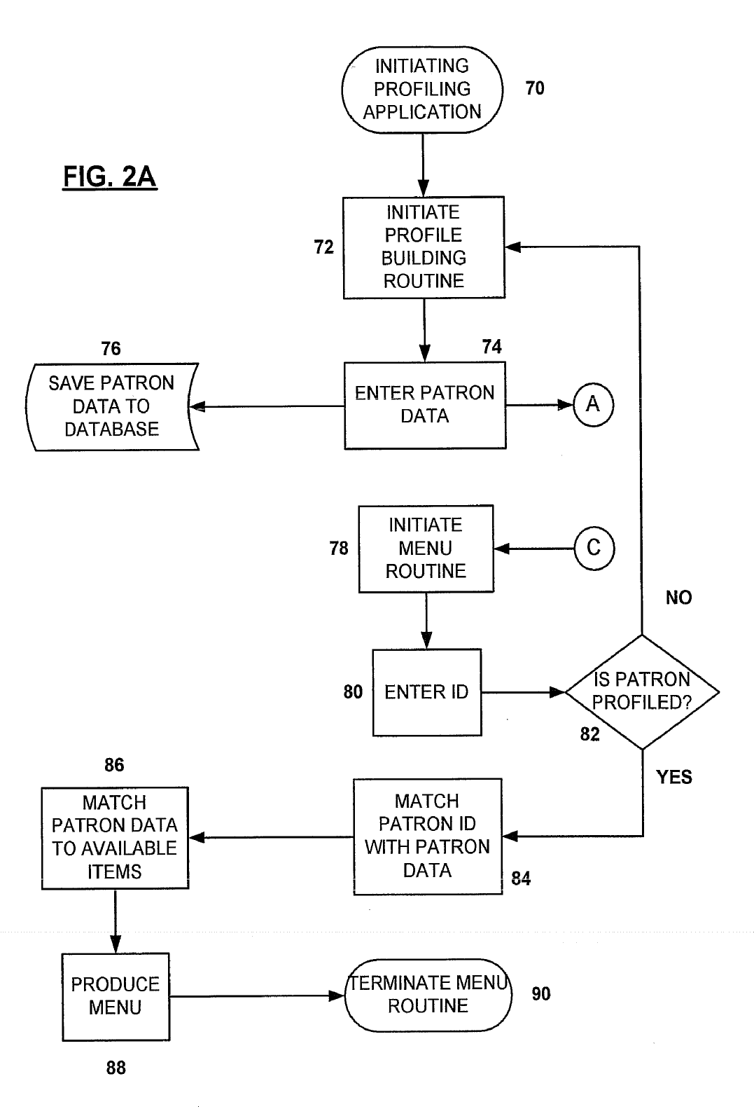

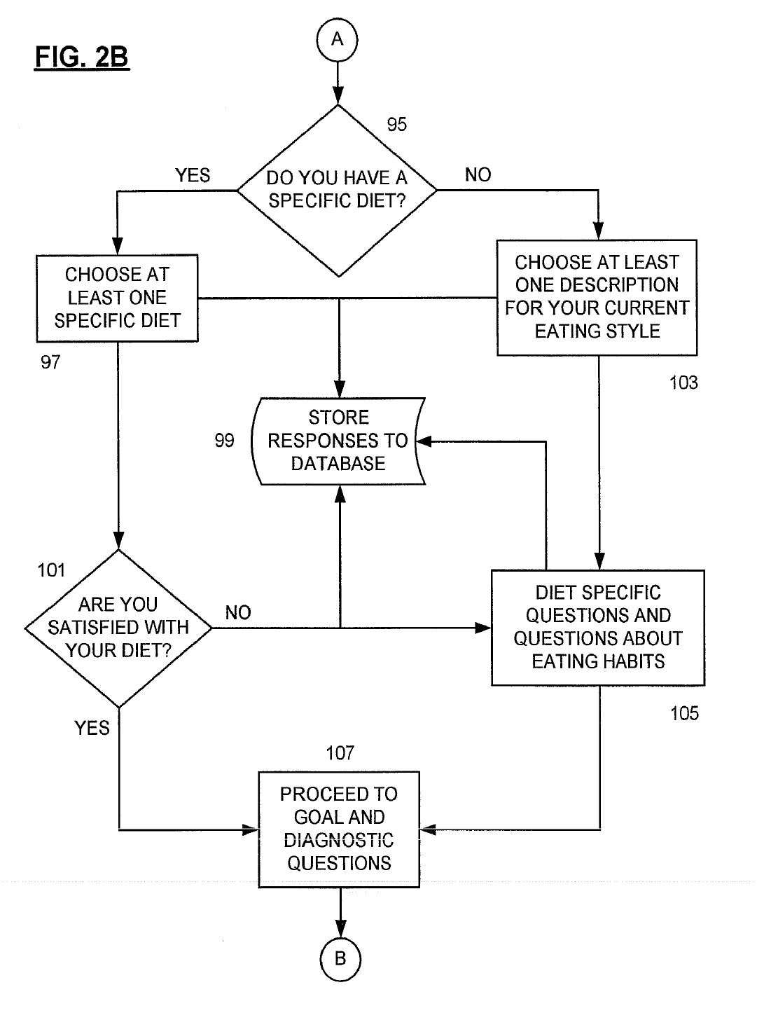

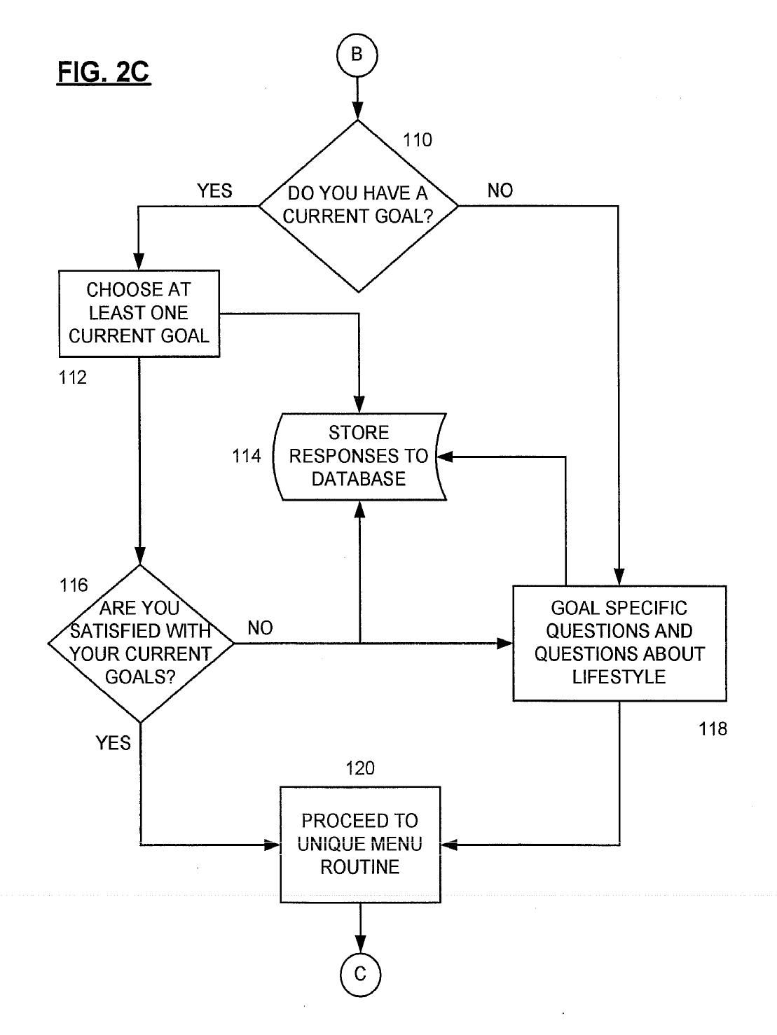

Referring now to FIG. 2A, there is shown an upper level flowchart of the method of the present invention. The method sequence begins at step 70 with the initiation of the nutritional profiling application. From step 70, the flow advances to step 72 where the profile building routine is initiated and the data relative to a specific patron is entered at step 74. From step 74, the flow advances along path A to FIG. 2B, from FIG. 2B to FIG. 2C along path B, and from FIG. 2C, the flow returns along path C to return to step 78. As a consequence of the data entered at step 74, and from FIGS. 2B and 2C, the data is saved to a database at step 76.

The flow continues at step 78 where a specific menu routine is initiated when a customer enters an eatery (such as a restaurant, diner or deli) that is networked within the system. The flow advances to step 80 where an eatery employee or the customer can enter identification by keyboarding the relevant data, swiping a fob or a card, or scanning a card. After the relevant data is entered into the system, the system will query itself at step 82 as to whether or not the customer has a stored profile.

If the response to the query at step 82 is “NO”, then the flow returns to step 72 where the customer can initiate a profile entry. If, however, the response to the query at step 82 is “YES”, then the customer is considered a patron and the flow advances to step 84 where the patron identification is matched with specific patron data in their profile to determine the patron's preferences. The flow advances to step 86 where the patron's data is matched against available ingredients at the eatery to determine a set of optimal menu choices at step 88. When the menu is produced, the menu routine terminates at step 90, though the actual menu choices will be captured when the patron actually places an order.

Turning next to FIG. 2B, there is shown a flow chart for questions concerning diet and eating habits. The flow enters FIG. 2B from step 74 along path A.

As shown, the first decision/question, step 95, concerning diet and eating habits is whether the patron is following at least one specific diet. If the user/customer is following at least one specific diet, step 97 asks the user/customer to identify the diet(s). Specific diets may include Zone, South Beach, Low Carb, Low Fat, High Protein, High Fat, High Fiber, Low Fiber, Vegan, Vegetarian, and No red meat. From step 97, the flow advances to the query at step 101 which asks whether the user/customer is satisfied with his or her current specific diet(s). If the patron is satisfied with his or her specific diet(s), the patron will be accelerated to step 107 which directs the flow along path B to re-enter at FIG. 2C to determine patron specific goals. If, however, the response to the query at step 101 is “NO”, then the flow advances to step 105 to answer diet specific questions and questions about the patron's eating habits.

If the patron did not indicate a specific diet at the query at step 95, then the flow advances to step 103 where the patron will choose at least one description for their current eating style. From step 103 the flow advances to step 105. If the patron is not satisfied with the specific diet(s), input step 105 will ask the patron to answer several diet specific questions and questions about eating habits. Alternatively, if the user is not following at least one specific diet, input step 3 asks the user to describe his or her current eating style. Preferably, the patron may select one or two eating styles. Eating styles may include No Specific Pattern, High Protein, High Fiber, Low Carbohydrate, Low Fat, Low Sodium, and Vegetarian. Once a patron has selected at least one eating style, input step 105 will ask the user/customer to answer several diet specific questions and questions about eating habits, after which the user proceeds to step 107 to enter path B.

Data derived from all responses is stored to a database at step 99 which is linked to steps 97, 101, 103 and 105.

The following are non-limiting examples of specific questions about diet to and eating habits that may be asked of the user for input step 105:

Are you following a total low carbohydrate plan, or a plan just low in sugar/simple carbs?

Are you following a total low fat plan, or a plan just low in animal fats and cholesterol?

Which animal foods do you avoid?

Do you follow any other dietary goals?

How many meals and snacks do you eat on a typical day?

How many 8-12-oz glasses of non-alcoholic fluids do you drink per day?

What are your weight goals?

Do you omit any foods from your diet due to food allergies or food sensitivities?

Select the foods you omit due to allergy or sensitivity.

Which of the following foods do you dislike?

1b. Questions Concerning Goals and Diagnostics

In this segment, we seek to learn more about the users' goals, as well as identify allergies, sensitivities, and overall preferences. The system must understand the goals of the user, as well as any condition(s) he or she may be currently treating, or trying to remedy. Goal-related questions may be Modifiers designed to bring specificity to contextual suggestion. The simplest example here is the answer “Weight-loss.”

Questions about Goals and Diagnostics are designed to be invasive and, therefore, as useful as the user wants it to be. For example, the question “Are you managing a specific medical condition?” is designed to set the user/customer on a specific pro-active, curative path to wellness. Thus, questions about Goals and Diagnostics can lead to informed dietary suggestions of extraordinary value, and unparalleled in food service. The system has to this point worked by starting with a universe of products and shrinking that universe for the answer to each question, which is obviously the most simple and best way to go, however in this last stage it could be best if some of the end products (i.e., food items) were tagged as specifically suited to certain diagnostic conditions.

Referring next to FIG. 2C, there is shown a flow chart for questions concerning nutritional goals. The flow enters FIG. 2C from step 107 along path B.

As shown, the first decision step (indicated as reference numeral 110) concerning diet and eating habits is whether the user/customer has at least one nutritional goal. If the user has at least one current goal, decision step 112 asks the user to identify the goal(s). Specific goals may include Weight Loss, Weight Gain, Weight Maintenance, Increased Energy, Reduced Fatigue, Enhanced Endurance, Better Focus, Concentration, and/or Memory, Heightened Libido, and Managing a Specific Medical Condition, including Cardiovascular (e.g., high blood pressure, high cholesterol, high triglycerides, heart disease), Gastrointestinal/Digestive (e.g., indigestion, irritable bowel syndrome, constipation, heartburn, acid reflux, ulcers, bloating, cramping, gas, diverticulosis, celiac, colitis, and Crohn's disease), Hormone and Immune conditions (e.g., diabetes and hypoglycemia, frequent colds, and recurring bladder infections), Psychological Problems, Blood Sugar Control, Arthritis or Joint Pain, Muscle Pain and/or Cramping, Osteoporosis, Decreased Headaches, Pain Management, and Improved Digestion, Asthma, Sinusitis, Anemia, Women's Health Issues (e.g., premenstrual syndrome, polycystic ovary syndrome, endometriosis, fibroids, and fibrocystic breasts), Men's Health Issues (e.g., prostate issues), Issues concerning Skin, Hair, and Nails (e.g., acne, psoriasis, eczema, oily hair, and brittle nails), and Cancer.

If the user is has at least one current goal, the query at input step 116 asks whether the user/customer is satisfied with his or her current goal. If the user/customer is satisfied with his or her goal(s), the user/customer will be accelerated to step 120 which leads the patron via path A to re-enter the flow at step 78 of FIG. 2A. However, if the user/customer is not satisfied with his or her goal(s), then the flow advances from the query at step 110 to input step 118 which asks the patron to answer several goal specific questions and questions about the patron's lifestyle. Having established goals and diagnostics, the system engineers the user's Unique Nutritional Identity (profile) as described herein below. The flow advances from step 118 to step 120 which leads the patron via path A to re-enter the flow at step 78 of FIG. 2A.

Data derived from all responses is stored to a database at step 114 which is linked to steps 112, 1116, and 118.

The following are non-limiting examples of specific questions about goals and lifestyle that may be asked of the user for input step 14:

What is your height?

What is your weight?

How much weight do you wish to gain?

How many pounds per week do you wish to gain?

Would you like to improve or prevent any of the following health conditions?

How many hours of sleep do you get per night on average?

Which of the following best characterizes your sleep quality?

What is your general stress level?

What is your general energy level?

What is your general mood?

Do you drink beer, wine or alcohol?

How many drinks do you have per week on average?

Do you smoke?

How many cigarettes do you smoke per day?

Do you incorporate any relaxation practices, including Hypnosis, Meditation, Prayer, Imagery, and Biofeedback?

Do you regularly utilize any bodywork, including Massage, Chiropractic/osteopathic, Manipulation, Physical Therapy, Reiki, Feldenkrais, Trager, Acupuncture, Myofascial Release, Craniosacral Therapy, Rolfing, and Alexander Technique?

1c. Unique Nutritional Identity and Unique Identity

Each user/customer is a unique nutritional identity that the system of the present invention captures through registration and profiling. Once the system engineers the user's Unique Nutritional Identity, the system works with the user to suggest menu combinations that better suit their personal goals. First, the user name and password are created.

Central to the present invention is the visual representation of the system's dynamic, contextual knowledge of the user and the creation of a unique user identity and profile. The visual representation may take various forms, e.g., triangles, circles, rings, rectilinear arrays, DNA helical twists without limitation of any kind etc. so that there is a consistency of the type of visual representation between user, but (like a DNA molecule itself) an ability to uniquely identify an infinite array of individuals.

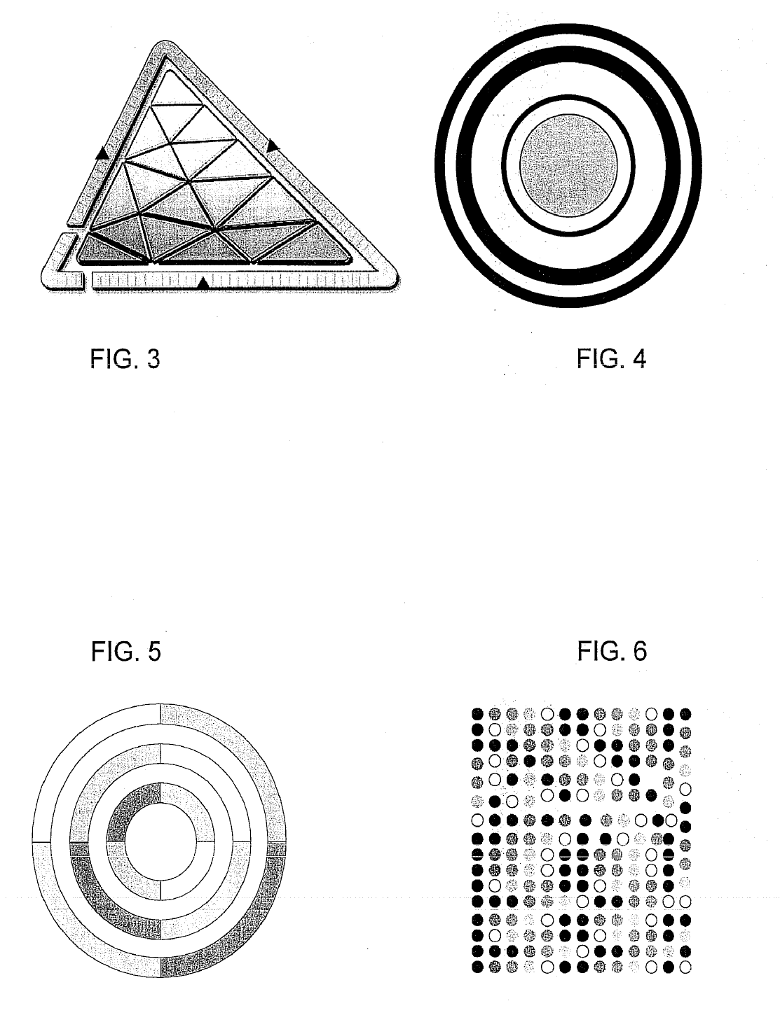

Referring to FIG. 3, the visual representation of the user may be a triangle. A triangle is evoked by the three states that represent the three different facets of each user. The first state or facet is the user's profile comprising user provided attributes. The second state, or facet, is the user's goals comprising user defined nutrition/health related milestones. The third state or facet is user balancing comprising system generated recommendations of product purchases that direct the user toward their goals. Each facet of the pyramid comprises cells that are each a discrete value in relation to its evoked state. For example, in the Balancing facet, the top cell may represent protein content and the bottom right cell may represent carbohydrate content. Significantly, cells that represent pivotal areas are highlighted as Critical Cells.

The visual representation of the user may be a set of rings and/or circles. The ring and/or circle set can be varied by, e.g., the number of rings and/or circles, as well as position, size, color, and/or segmentation, based on the user's preferences and needs.

For example, referring to FIG. 4, there is shown a circle and ring set, wherein a user's profile is visually represented by a core circle surrounded by three rings of varying size and position. The core circle is Low Sugar, which represents a user's core preference and/or need for a low sugar diet. The first ring is Added Protein, the innermost position of which indicates high importance, and the small size of which indicates high current compliance by the user with this preference/need. The second ring is Vegetarian, the middle position of which indicates middle importance, and the larger size of which indicates lower current compliance by the user with this preference/need. The third ring is Dairy Free, the outermost position of which indicates lower importance, and the middle size of which indicates a middle amount of current compliance by the user with this preference/need. Furthermore, the second ring is closer to the third ring and farther from the first ring resulting in a visual representation of two groups: Low Sugar with Added Protein, and Vegetarian with Dairy Free. This grouping of the circle and rings visually represents the user's need for low sugar and added protein with the user's preference for Vegetarian and Dairy Free.

Alternatively, referring to FIG. 5, there is shown a ring set, wherein a user's profile is visually represented by three rings of fixed size and position, but varying segments. The outer ring is the user's current state. The middle ring is the user's goals. The inner ring is the system's recommendations for the user. Each ring is divided into segments or cells representing particular nutrition properties. The intensity of color in each cell represents the particular nutrition score in relation to the user's preferences' and/or needs.

Referring to FIG. 6, there is shown another alternative visual representation of the system's dynamic, contextual knowledge of the user in the form of a rectangular array of circles. The array and/or circles can be varied based on the user's preferences and needs by, e.g., the total number of circles in the array, the number of circles in each row or column, as well as the position, size, color, and/or segmentation or visual, audio, or other representation of each circle or array of circles (or other indicia) represents the unit identity of each member/user as a sort of “DNA-label” that is different from any other member/user, and may change with time depending upon the earlier noted inputs and profiling details created in the managing database. In a preferred embodiment, the user's preferences and needs (the so-called DNA-label) are shown in the array as a vertical arrangement of horizontal rows, i.e., the top several horizontal rows are indicative of the user's current state, the middle several rows are indicative of the user's goals, and the bottom several rows are indicative of the system's recommendations for the user. Whether a particular circle in a given row is visible or not, and the color of each visible circle, are based on the user's unique preferences and/or needs in light of the information provided to the system by the user.

1f. Example Registration and Profiling

Upon accessing the system of the present invention for the first time, a new user must create a unique username and password. The system then requests demographic information from the user to begin creating the user's profile. Accordingly, the system inquires about the user's age, how many meals the user eats per day, whether the user's work is physically demanding, how many hours does the user exercise per week, what methods of exercise does the user prefer, whether the user suffers from a medical condition or has any allergies, as well as whether the user follows a particular diet.

After the demographic information, which is also referred to herein as the user's current state, the system then requests goal-oriented information. The system asks the user to describe what the user wants to accomplish in his or her diet, including nutrition goals and deadlines (e.g., how many days to loss a certain amount of weight).

The system can then ask whether the user would like to make his or her non-personal profile information viewable to other users in the community. Enabling this makes it easy for other users with similar attributes to communicate with the user to share tips, discussion topics, etc.

### 2. Virtual, Interconnected, Community Eating

Virtual, interconnected, community eating (VICE) comprises technologies to facilitate the audio-visual connection of any user any other user anywhere. Also, within a restaurant, VICE refers to visual media to define the ambiance, amplify locale, and entertain, including bleachers; communal tables, and multilevel bars to re-engineer space utilization.

2a. Unique Auto-Marketing

The profile ability of the proposed system enables tracking for each user and of course tracks every meal that the user has ever ordered in store, by location, time and other information unique to the circumstance, and therefore generates a unique, one-time, event that cannot be repeated and is understood collectively as an ‘order history’ or user activity. The system shows the user's order history, member points, and eligible promotions/discounts. When creating (e.g., building) a customized meal (whole meal) or food product (burger, salad, taco, pizza, etc., for example “Dave's Pizza with squash”), the user can “name” their meals and or individual items. A named meal or item created and named by a user is categorized by the system, noticed to other members that match the meal's category, as well as other appropriate communities (i.e., groups of members with a common attribute). For example, an item categorized by the system as low carbohydrate can be noticed to other members with low carbohydrate profiles, as well as calorie counters, anti-oxidant seekers, or diabetics. Moreover, a unique meal or item created (built) and named by a user can be marketed with a personal message from the user throughout the entire community or outside the community so as to generate cross-linked interested and later use by other member/users of the unique meal. If any other member orders a meal or item that is marketed by the user, the system can award the user points or other benefits for use in store. The user can also notice a meal or item to non-members, e.g., via e-mail or SMS message, or in any other communication medium now known or created in the future. Any activity by a user that enhances the community can be rewarded with points or other benefits, such as coupons, discounts, free gifts, or expanded electronic abilities within the system.

2b. Whole Burgers (a Representational Build)

Common sandwiches, such as hamburgers, contain solid patties that take substantially longer to cook in the center than the outside and do not readily accommodate additional ingredients, such as portions of vegetables, which invariably slip off the patty causing the sandwich to slide apart. This problem has made hamburgers and hamburger-like sandwiches, including cheeseburgers, fish burgers, soy burgers, and veggie burgers, difficult to vary and adapt to regional and ethic tastes.

Whole burgers contain a patty with a hole in its center that is filled, e.g., with a wide variety of fresh and/or cooked vegetables in almost infinitely variety. A unique aspect of the whole-burger is the hole in the center of the patty that reduces fat, speeds cook time, and secures the vegetable portions. A second unique aspect of the whole-burger are the ducts running along the radius of the patty to facilitate the distribution of flavor and nutrients from the filling at the core of the patty. A third unique aspect of the whole burger is the portions of vegetables that are sized to fit in the hole of the patty. A fourth unique aspect of the whole burger is the top seal created at the top of the center hole that creates the air pressure (when squeezed) required to push juice through the ducts in the patty.

The assembled whole burger comprises of the following components: a sandwich roll, a patty with a hole in its center, a filling shaped and sized to fit inside the hole, and a cover shaped to seal the hole and secure the filling therein. The assembled whole burger may also comprise other components, including various condiments (e.g., teriyaki sauce, catsup, chutney, tahini, mayonnaise, and barbecue sauce), cheese, lettuce, tomato, bacon strips, onion rings, etc. The patty can comprise any protein source, e.g., meat, beans, etc. Preferably, patty is ring-shaped and the hole corresponds to approximately 25-30% of the total volume of the patty. Whole burgers can be constructed with a wide variety of breads and rolls, including: leavened bread; pita; roti; corn arepas; etc. The filling preferably comprises one or more of a wide variety of intense flavors and/or vegetables, including chickpeas, avocado, tomatoes, eggplant, snap beans, mushrooms, basil, green beans, peanuts, common beans, endive, maize, peppers, yams, dill, carrots, cabbage, squash, and cauliflower. The filling may also comprise specific medicinal qualities, e.g., antioxidants, asthma care, and flu therapy.

To assemble the whole burger, optional condiments are spread on the bottom roll, a patty is placed on the roll, optional cherry tomatoes are placed around the patty so as not to encroach the hole, optional cheese (preferably with a hole in the center) is placed on the optional tomatoes or directly on the patty, a user-selected filling is scooped into the hole, a cover (e.g., a small round of deli meat) is placed over the filling, optional lettuce is placed over the lower components and the upper roll tops the entire assembly.

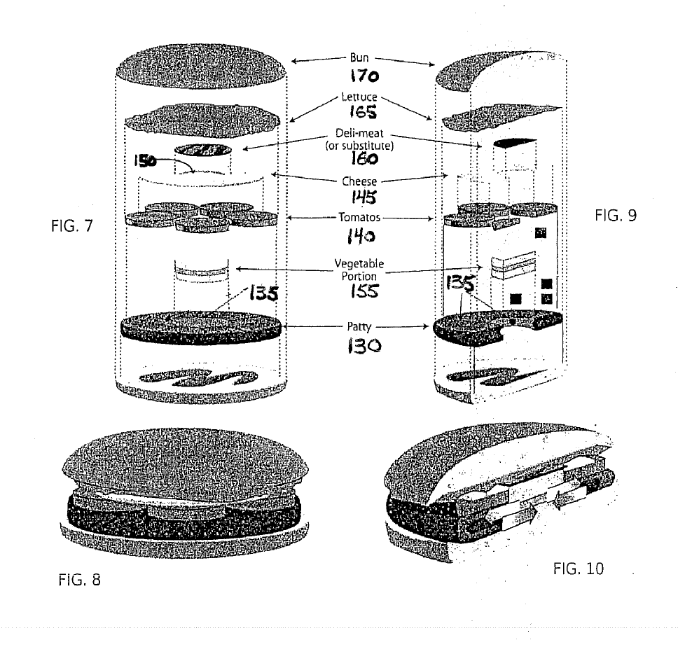

Referring to FIGS. 7 and 8, there is shown a preferred whole burger of the present system and method comprising patty 130 with a hole 135 in its center. Optional tomatoes 140 are arranged around the hole 135. Cheese 145 is laid on top of the tomatoes 140. Preferably, the cheese 145 has a hole 150. The effect of these three components arranged in this way is to create a cylinder into which a filling 155 (e.g., portions of vegetables) is placed. A round of deli meat 160 or non-meat substitute covers the filling 155 (preferably, slightly overlapping the cheese 145). Lettuce 165 provides a secondary seal. All these components are sandwiched within a roll 170. Optionally, referring to FIGS. 9 and 10, patty 10 may comprise radial channels 180. Holing the assembled whole burger comprising channels 180 has the effect of forcing the filling 155 through radial channels 180.

2c. Smart Receipt

Smart Receipts deliver added value to the user and encourage return and repeat business. When the user purchases items in a restaurant, not only does the user receive a paper smart receipt, in addition, an electronic smart receipt is added to the user's profile. In addition to the traditional information included in a receipt (e.g., items purchased, date and time of purchase, method of payment, etc.), the system embeds additional services within the smart receipts, including graphic information about the meal and/or user, and special offers for future purchases, which offers can be personalized to a user's preferences which are stored on the user's profile. Additionally, alternative visual presentations may be presented on the ‘smart receipt’ such as a coupon portion, a naming region for a customized ‘built’ product, a designation of points to a user/members point tracking category or in an_{y} other way enabled by the proposed system and method.

2d. Example In-Restaurant Experience

In store, a cashier will ask whether the customer is a current user of the system. If the customer is not a current user, the cashier can assist the customer with creating a new profile. If the customer is indeed a current user, the customer can provide the cashier with his or her username. The customer can then order a meal of his or her choosing, e.g., a tuna burger with a “mediterranean veggie-scoop” on seven-grain bread. Based on the customer's user profile, the cashier can suggest an alternative meal that better suit the customer's goals. For example, if the customer has a low carbohydrate profile, instead of the tuna burger, the cashier may suggest tuna nuggets with cottage cheese and spinach to minimize the carbohydrate content of the customer's meal. The customer may or may not accept the cashier's suggestion. For example, if the customer has eaten only vegetables that day, the customer can afford a meal with a higher amount of carbohydrates and still follow his or her low carbohydrate profile. Furthermore, the cashier can suggest additional meal items, including a healthy side, a fortified beverage, and a fortified dessert, that match the customer's goals. For example, the cashier can suggest rice, a beverage fortified with antioxidants, and a frozen yogurt. In this way, the cashier is a diet and nutrition coach for the customer.

At the end of the transaction, the customer receives a paper smart receipt from the cashier, and an electronic smart receipt of the transaction is stored in the user's profile. The paper smart receipt can show the pyramid for the meal and the pyramid for the customer so the customer can easy see whether of not their meal choice match their goals. In addition, if the customer did not choose the menu suggested by the cashier, the paper smart receipt may afford the customer a discount if the customer returns to order the menu suggested by the cashier.

### 3. Communications, Hardware, and Software

The present invention provides a system and method for providing customized, interactive and flexible nutritional counseling. The system may provide such counseling to multiple users, and to a single user via multiple different communications channels.

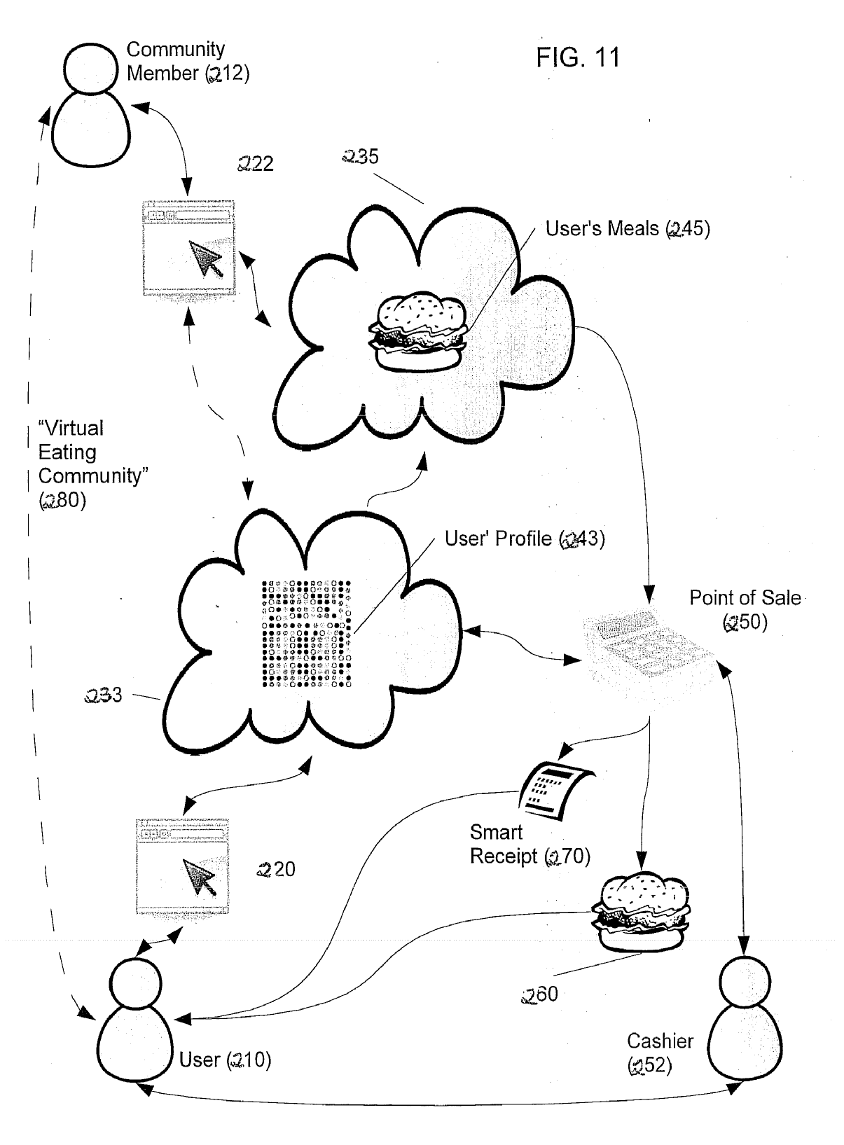

FIG. 11 is a schematic diagram illustrating diagrammatically exemplary communications for the system of the present invention between users 210 and 212, the user interfaces 220 and 222, the distributed server clouds (233 and 235) comprising user and food databases clouds (243 and 245, respectively), and a restaurant/point-of-sale 250 (including a cashier or customer service person 252). The result of these communications comprises a meal 260 for the user to consume, and a smart receipt 270. When two or more users communicate with the system of the present invention, a virtual eating community 280 is defined.

One communications channel involves a first user's access or interface 220 adapted to communicate with a distributed server cloud 233 comprising the first user's profile 243. The user's access or interface 220 is also adapted to communicate with a distributed server cloud 235 comprising a food database 245. The first user's interface 220 comprises, e.g., a desktop, laptop, notebook, tablet, or similar device, that communicates via, e.g., the Internet, LAN, or WAN, using appropriate communications hardware, software, and technologies. For example, an e-mail or website interface may be provided for this purpose. The interface 222 may also comprise a mobile computing device, such as a wireless telephone, PDA, etc. For example, the device may be configured to use MMS, SMS text messaging, IM instant messaging technology, an e-mail interface, web or WAP interface, etc., using appropriate communications hardware, software, and technologies.

A second communications channel as shown in FIG. 11 involves a second user's access or interface 222, e.g., a desktop, laptop, notebook, tablet, or similar device, adapted to communicate with the distributed server cloud 235 comprising the food database 245 via, e.g., the Internet, LAN, or WAN, using appropriate communications hardware, software, and technologies. For example, an e-mail or website interface may be provided for this purpose. The interface 222 may also comprise a mobile computing device, such as a wireless telephone, PDA, etc. For example, the device may be configured to use MMS, SMS text messaging, IM instant messaging technology, an e-mail interface, web or WAP interface, etc., using appropriate communications hardware, software, and technologies. For privacy, of course, as shown by the one-way connection between clouds 233 and 235, the second user's interface 222 may not be adapted to communication with the distributed server cloud 233 comprising the first user's profile 243. However, the first user may elect to make at least a portion of his or her profile publicly available. In that situation, a temporary or limited connection (indicated by a dashed line) may be established between second user interface 222 and cloud 233.

The clouds 233 and 235 include software specially configured in accordance with the present invention. The clouds 233 and 235 include various software-implemented components, including a communications parser for parsing communications received from users, e.g., via e-mail message, text message, etc. Software programming code for carrying out the inventive method is typically stored in memory. Accordingly, the clouds 233 and 235 comprise memory and microprocessor executable instructions including programs for carrying out the methods described herein. For example, the cloud 233 stores instructions configured to obtain and store user information, instructions configured to develop, identify and/or assign a user profile to a user, instructions configured to exchange information with a user, instructions configured to recommend a compliant food item/meal (collectively, “meal”) that matches and/or falls within acceptable parameters corresponding to the user's profile information, instructions configured to identify a next recommended meal to nutritionally compensate for a previously consumed meal, and instructions configured to transmit a relevant motivational message to a user.

The clouds 233 and 235 also store databases. For example, cloud 233 stores a database 243 of user profile information that includes one or more default profiles as well as customized user profiles built as users register with the system and cloud 235 stores a database 245 comprising food consumption for each user, nutritional information for various food items, meals, diets, etc. The nutritional information may include nutritional content information, such as carbohydrate, protein, fat and calorie content, ingredient information for various meals, food consumption guidelines corresponding to recommendations and standards, medical conditions, diet objectives, etc. Accordingly, for example, the database of nutritional information may include, for each food item, calories, calories from carbohydrates, calories from fat, calories from protein, total fat, saturate fat, cholesterol, sodium, total carbohydrate, dietary fiber, starch, sugars, and protein content, etc. The database of nutritional information may also include recommended food portion sizes and weights, a listing of ingredients, etc. By way of example, nutritional information may be obtained by adapting the USDA Nutritional Database; a database of recipes/ingredients may be created or obtained.

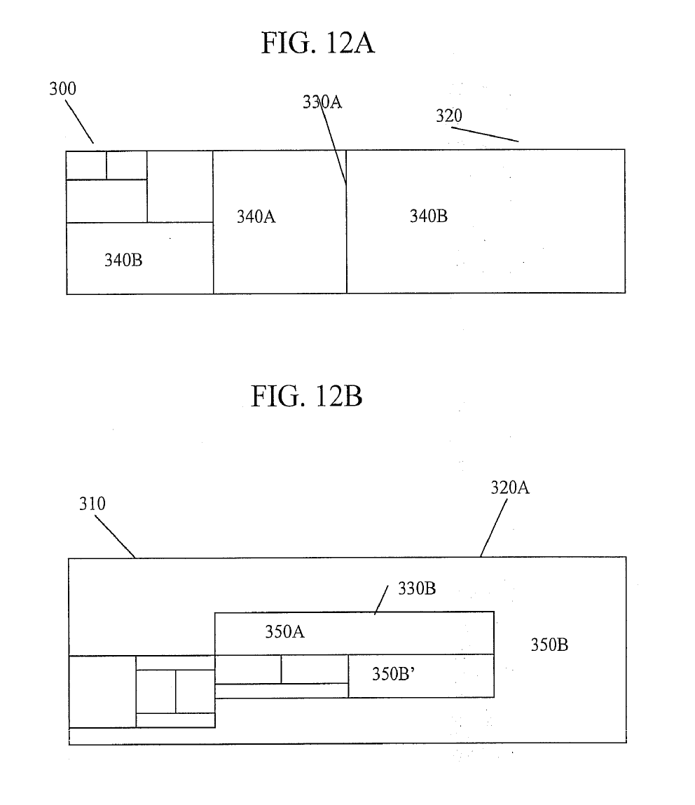

Referring additionally now to FIGS. 12A and 12B as representational (illustrative) organized combination 300 and disorganized combination 310 diagrams of the possible combinations managed by the earlier discussed hardware and software enabling a unique database construction and management system for supporting the virtual eating community 280 with an infinite, or nearly infinite, number of combinations while still remaining as a definite sum bounded by a mathematical resolution that subject to a calculus. In this way, the earlier noted system supports a customized and customizable combination of user profiles 243, smart receipt details 220, built-meals/burgers 245, meal tracking 260, and each and every one of the communications noted within FIG. 11 as a type of cross-pollination throughout the managed system. In this way, those of skill in the art will readily recognize that the presently proposed system and method may be readily adapted to other communities, particularly but not limited to the food services industry. For example, as discussed fully herein, the proposed system and method may be easily applied to a pizza, taco, restaurant, ice cream, or specialty food provider without departing from the scope and spirit of the present invention.

Particularly as viewed in the respective organized 300 and disorganized 310 combination diagrams representing the infinite combinations an initial system database boundary of preliminary inputs is determined at respectively 320A, 320B. Thereafter a first user 210 (see FIG. 11) inputs the earlier noted profiling and registration details, selects a meal or food item and through other action creates a unique division or region 330A, 330B within the overall database.

As noted in FIG. 12A, the particular division 330A regularly bisects the possible combinations into those for the user/member 210 shown as area 340A, and an area 340B not for the user/member 340B. Similarly, to illustrate a disorganized division in FIG. 12B a user/member 210 crates a user area 350A and an area representing a not for user/member region 350B.

As will be understood by those of skill in the art of database and system management, an infinite combination of regions that are linked with each respective user/member 212 may be defined through the user/members interaction with the virtual eating community 280. In either type of illustrated representation each respective region may be sub-divided into a user-linked region (represented by A's) and a non-linked region (represented by B's). So, for example in FIG. 12A, area 340A may be further divided into linked areas 340A′ and 340B′, and thereafter into further sub-sub-links 340A″ and 340B″, and so forth. Similarly, in FIG. 12B, area 350A may be further divided into sub-linked areas 350A′ and 350B′, and thereafter into 350A″ and 350B″, and so forth. Each of the sub-linked areas, for an infinite progression, is reflective of customized combinations. Of course, since FIGS. 12A and 12B are illustrative of an infinite expandable field of cross-linked combination for the proposed system and method, a ‘third-dimension’ (e.g., depth equaling interaction with a plurality of users and features) will also be recognized by those of skill in the art so that through extended operation an ever expanding and multi-liked community may be easily managed.

In this way, at any time another user/member orders the same build or meal or item as created by an originator this action will be linked back to the originator providing a customized benefit. Similarly in this way, the proposed system and method enable a way to assess the value of the customization ability of the proposed interactive and flexible system so that the value does not diminish over time. For example, employing the rewards database system will generate a determination over time of what combination of builds works commercially, is popular commercially, by geographic region, etc. As a consequence, those of skill in the art recognize that the proposed system and method enable multi-tiered data-mining action by managing an ever-expanding database system and structure tied to unique user profiles.

As used herein the phrases “build” or “built” used in relation to food combinations or meals or burgers created by particular users will be understood as representing the creation of a personalized combination unique to the particular user/member that may be thereafter input to the management software as a customized “entry”; and which may thereafter be promoted to other user/members via the user community or virtual eating community 180.

As used herein, the phrase “DNA-label” will not be viewed as a strictly biological term (namely as deoxyribonucleic acid) but instead as a representational or descriptive moniker or phrase that indicates the ability of the present system to indicate, track, and manage uniqueness for each user/member and indicates the sum of all the particular registration, profiling, use, and cross-linking activity within the system community by the particular user/member in a way that is determined by the system managers and database control parameters similarly applied to each user/member of the community. In this way the phrase “DNA-Label” or “DNA” will be recognized by those of skill in the art having reviewed and understood the entire disclosure as having a particular and specific descriptive meaning within the scope and spirit of the present invention.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of establishing a set of nutritional profiles in a data processing system wherein each of said profiles is utilized to establish an optimal meal menu at a given time and location and with regard to a set of available ingredients relative to said given location, said method further comprising the steps of:
(a) initiating a profile building routine;
(b) entering a set of characteristics of a particular individual into a data file established for said individual;
(c) saving said set of characteristics to a first database so as to be accessible to database queries for individual file data;
(d) aggregating said set of characteristics within said first database with data saved for the set of all individual patrons entered into said first database;
(e) initiating a menu routine, at a networked eatery, for entering a set of identification information relative to a patron;
(f) first matching said set of identification information relative to said patron with said aggregated data to determine a patron match;
(g) second matching said patron match with said set of characteristics to determine an optimal menu plan; and
(h) third matching said optimal menu plan with said set of available ingredients for said networked eatery to produce a menu for said patron.

2. The method of claim 1, further comprising the step of creating a set of one or more categories within said set of all individual patrons, wherein each of said categories is representative of a group of individual patrons who share a scored characteristic band.

3. The method of claim 2, wherein said characteristic band is calculated by adding points assigned to each of characteristic within said set of characteristics.

4. The method of claim 1, wherein said patron selects meal items from said menu and wherein further:
(a) said selected meal items are recorded to said nutritional profile by said data processing system; and
(b) said user profile tracks every food item that said patron has ordered in said eatery, said food item being named by said patron, categorized by said data processing system, and noticed to other members that match said selected meal's category.

5. The method of claim 1, further comprising the step of maintaining a forms library within a second database of said data processing system and wherein said forms represent one or more report formats.

6. The method of claim 5, wherein said report formats depict a menu for said individual for a given meal and based upon a set of ingredients available at a selected location.

7. The method of claim 5, wherein said first database and said second database are co-located.

8. The method of claim 1, wherein said set of characteristics include characteristics defining said particular individual's specific diet requirements.

9. The method of claim 1, wherein said set of characteristics include characteristics defining said particular individual's specific nutritional goals.

10. The method of claim 1, wherein said user profile tracks every food item that said user has ordered in said eatery, said food item being named by said user, categorized by said system, and noticed to other members that match the meal's category.

11. The method of claim 1, further comprising a visual representation of the profile of said individual patron.

12. The method of claim 11, wherein said visual representation is a pyramid evoked by a set of three facets representing three different states of said patron, said set of three facets further comprising:
(a) a first facet being said patron's profile and comprising a set of user provided attributes;
(b) a second facet being said patron's goals and comprising patron defined nutrition/health related milestones; and
(c) a third facet being a balancing point further comprising system generated recommendations of product purchases that direct said patron toward his or her goals.

13. The method of claim 11, wherein said visual representation is a set of rings and circles, wherein:
(a) a patron's profile is visually represented by a core circle surrounded by a plurality of rings of varying size and position;
(b) said core circle being said patron's core preference or need;
(c) said rings being each an additional preference or need of said patron;
(d) the position of each of said rings indicating relative importance of the respective addition preference or need; and
(e) the size of each of said rings indicating the relative current level of compliance by said patron with the respective additional preference or need.

14. The method of claim 11, wherein said visual representation is a ring set, wherein:
(a) said patron's profile is visually represented by three rings of fixed size and position, but varying segments;
(b) the outer ring being said patron's current state;
(c) the middle ring being the user's goals;
(d) the inner ring being the systems recommendations for the user; and
(e) wherein each ring is divided into a plurality of segments or cells representing particular nutrition properties and the intensity of color in each cell represents the particular nutrition score in relation to said patron's preferences or needs.

15. The method of claim 11, wherein said visual representation is an array of circles disposed in several horizontal rows, wherein:
(a) a first set of horizontal rows is indicative of said patron's current state;
(b) a second set of several rows are indicative of said patron's goals; and
(c) a third set of several rows are indicative of said system's recommendations for said patron.

16. The method of claim 1, wherein said initiating step further comprises the step of entering said identification information in said menu routine of a node located in said eatery and wherein said node is in communication with said data processing center.

17. The method of claim 16, wherein said identification information is entered into said menu routine by selecting a step from the following group:
(a) entering said identification information into said routine by using a keyboard interoperatively connected to said node;
(b) entering said identification by swiping a fob containing said identification information past a reader interoperatively connected to said node; and
(c) entering said identification by swiping a card containing said identification information past a reader interoperatively connected to said node.

18. A system for establishing a set of nutritional profiles wherein each of said profiles is utilized to establish an optimal meal menu at a given time and location and with regard to a set of available ingredients relative to said given location, said system further comprising:
(a) a centralized data processing system further comprising a set of routines for initiating, storing and comparing nutritional profiles;
(b) a memory in said system for storing and aggregating a set of characteristics of a particular individual patron, together with characteristics from other patrons, in a data file established for said individual and accessible to database queries for individual file data;
(c) a menu routine, at a networked eatery, for entering a set of identification information relative to a patron of said networked eatery;
(d) first matching means for matching said set of identification information relative to said patron with said aggregated data to determine a patron match;
(e) second matching means for matching said patron match with said set of characteristics to determine an optimal menu plan; and
(f) third matching means for matching said optimal menu plan with said set of available ingredients for said networked eatery to produce a menu for said patron.

19. The system of claim 18, further comprising a set of one or more categories within said set of all individual patrons, wherein each of said categories is representative of a group of individual patrons who share a scored characteristic band.

20. The system of claim 19, wherein said characteristic band is calculated by adding points assigned to each of characteristic within said set of characteristics.

21. The system of claim 18, wherein said patron selects meal items from said menu and wherein further:
(a) said selected meal items are recorded to said nutritional profile by said data processing system; and
(b) said user profile tracks every food item that said patron has ordered in said eatery, said food item being named by said patron, categorized by said data processing system, and noticed to other members that match said selected meal's category.

22. The system of claim 18, further comprising a forms library within a second database of said data processing system and wherein said forms represent one or more report formats.

23. The system of claim 18, wherein said report formats depict a menu for said individual for a given meal and based upon a set of ingredients available at a selected location.

24. The system of claim 18, wherein said first database and said second database are co-located.

25. The system of claim 18, wherein said set of characteristics include characteristics defining said particular individual's specific diet requirements.

26. The system of claim 18, wherein said set of characteristics include characteristics defining said particular individual's specific nutritional goals.

27. The system of claim 18, wherein said user profile tracks every food item that said user has ordered in said eatery, said food item being named by said user, categorized by said system, and noticed to other members that match the meal's category.

28. The system of claim 18, further comprising a visual representation of the profile of said individual patron.

29. The system of claim 28, wherein said visual representation is a pyramid evoked by a set of three facets representing three different states of said patron, said set of three facets further comprising:
(a) a first facet being said patron's profile and comprising a set of user provided attributes;
(b) a second facet being said patron's goals and comprising patron defined nutrition/health related milestones; and
(c) a third facet being a balancing point further comprising system generated recommendations of product purchases that direct said patron toward his or her goals.

30. The system of claim 28, wherein said visual representation is a set of rings and circles, wherein:
(a) a patron's profile is visually represented by a core circle surrounded by a plurality of rings of varying size and position;
(b) said core circle being said patron's core preference or need;
(c) said rings being each an additional preference or need of said patron;
(d) the position of each of said rings indicating relative importance of the respective addition preference or need; and
(e) the size of each of said rings indicating the relative current level of compliance by said patron with the respective additional preference or need.

31. The system of claim 28, wherein said visual representation is a ring set, wherein:
(a) said patron's profile is visually represented by three rings of fixed size and position, but varying segments;
(b) the outer ring being said patron's current state;
(c) the middle ring being the user's goals;
(d) the inner ring being the systems recommendations for the user; and
(e) wherein each ring is divided into a plurality of segments or cells representing particular nutrition properties and the intensity of color in each cell represents the particular nutrition score in relation to said patron's preferences or needs.

32. The system of claim 28, wherein said visual representation is an array of circles disposed in several horizontal rows, wherein:
(a) a first set of horizontal rows is indicative of said patron's current state;
(b) a second set of several rows are indicative of said patron's goals; and
(c) a third set of several rows are indicative of said system's recommendations for said patron.

33. The system of claim 18, wherein said eatery further comprises a node, said node including entry means for entering said identification information in said menu routine of said node and wherein said node is in communication with said data processing center.

34. The system of claim 18, wherein said identification information is entered into said menu routine by entry means selected from the group comprising:
(a) a keyboard interoperatively connected to said node;
(b) a fob containing said identification information and capable of being moved past a reader interoperatively connected to said node; and
(c) a card containing said identification information and capable of being swiped through a reader interoperatively connected to said node.

35. A method of establishing a set of nutritional profiles in a data processing system wherein each of said profiles is utilized to establish an optimal meal menu at a given time and location and with regard to a set of available ingredients relative to said given location, said method further comprising the steps of:
(a) initiating a profile building routine within said data processing system and entering a set of characteristics of a particular individual into a data file established for said individual;
(b) saving said set of characteristics to a database of said data processing system so as to be accessible to database queries for individual file data;
(c) aggregating said set of characteristics within said database with data saved for the set of all individual patrons entered into said database;
(d) initiating a menu routine, at a networked eatery, for entering a set of identification information relative to a patron, said network eatery interoperatively connected to said data processing system by communication means for communicating therebetween;
(e) first matching said set of identification information relative to said patron with said aggregated data to determine a patron match;
(f) second matching said patron match with said set of characteristics to determine an optimal menu plan;
(g) third matching said optimal menu plan with said set of available ingredients for said networked eatery to produce a menu for said patron; and
(h) producing a report indicative of said patron's profile wherein said profile further comprising a visual representation of said profile of said individual patron.

36. A method of establishing, in a data processing system, a set of nutritional profiles for an eatery patron, wherein each of said profiles is utilized to establish an optimal meal menu at a given time and location and with regard to a set of available ingredients relative to said given location, said method further comprising the steps of:
(a) tracking each use of said system by said eatery patron by using a pre-determined set of categories in which to record said each use;
(b) creating a customized meal in respect of said optimal meal menu;
(c) naming said meal;
(d) categorizing said meal in accordance with a set of parameters;
(e) sending a notice to other users of said system, said notice identifying said named meal; and
(f) awarding points to said eatery patron, in respect of said named meal, said points being applicable against goods and/or services available from a vendor.

37. The method of claim 36, wherein said awarded points are accumulated in said eatery patron's system account until used to purchase goods or services in respect of said points.

38. The method of claim 36, further comprising the step of generating a smart receipt in respect of a system use by said eatery patron, said smart receipt further comprising:
(a) a record of said transaction;
(b) a record of points issued in respect of said transaction; and
(c) one or more visual presentations.

39. A system for establishing, in a data processing system, a set of nutritional profiles for an eatery patron, wherein each of said profiles is utilized to establish an optimal meal menu at a given time and location and with regard to a set of available ingredients relative to said given location, said method further comprising the steps of:
(a) tracking means for tracking each use of said system by said eatery patron by using a pre-determined set of categories in which to record said each use;
(b) a customized meal created in respect of said optimal meal menu, and wherein said meal is given a unique name;
(d) assignment means within said system for assigning a category to said meal in accordance with a set of parameters;
(e) communication means for sending a notice to other users of said system, said notice identifying said named meal; and
(f) point tabulation and accounting means for accounting points issued to said eatery patron, in respect of said named meal, said points being applicable against goods and/or services available from a vendor.

40. The system of claim 39, wherein said awarded points are accumulated in said eatery patron's system account until used to purchase goods or services in respect of said points.

41. The method of claim 39, further comprising a smart receipt generated in respect of a system use by said eatery patron, said smart receipt further comprising:
(a) a record of said transaction;
(b) a record of points issued in respect of said transaction; and
(c) one or more visual presentations.
